(19) United States
(12) Patent Application Publication
(10) Pub. No.: US 2025/0391898 A1
(43) Pub. Date: Dec. 25, 2025

(54) FUEL CELL SYSTEM AND ASSEMBLY OF THE SAME

(71) Applicant: GM Global Technology Operations LLC, Detroit, MI (US)

(72) Inventors: Bhuvaneswara Rao Dharmavarapu, Rochester Hills, MI (US); Sreekanth Tiptur Narahari, Bengaluru (IN); Sharath Shankar Rao, Bengaluru (IN); Joseph P. Truchan, Oxford, MI (US); Venkata Subba Rao Mattupalli, Bengaluru (IN); Daniel Blair, Rochester Hills, MI (US)

(73) Assignee: GM Global Technology Operations LLC, Detroit, MI (US)

(21) Appl. No.: 18/750,744

(22) Filed: Jun. 21, 2024

(51) Int. Cl. H01M 8/2475; B60L 50/72

(52) U.S. Cl. CPC H01M 8/2475; B60L 50/72; H01M 2250/20

(57) ABSTRACT

A fuel cell stack, comprising a fuel cell stack case comprising a chamber extending between a first end and a second end and one or more fuel cells arranged in the chamber of the fuel cell stack case. The fuel cell stack further comprising a first end plate coupled to the first end of the fuel cell stack case and including one or more first datum rail receptacles, a second end plate coupled to the second end of the fuel cell stack case and including one or more second datum rail receptacles spaced axially from the first datum rail receptacles with respect to a first axis, and one or more datum rails coupled to and extending between the one or more first datum rail receptacles and the one or more second datum rail receptacles.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to fuel cell systems and, more particularly, to assembly of one or more datum rails in a fuel cell stack.

In general, a fuel cell stack system requires assembling (e.g., stacking) one or more plates that are eventually compressed together into a stack. One or more guides or support rails may be used during assembly to constrain and align the one or more plates with respect to one another. The one or more guides or support rails commonly remain in the stack after the assembly process is completed and can act as an insulator to a metal casing surrounding the stack. Existing systems rely on fasteners to secure the one or more guides or support rails to top and/or bottom end plates of the fuel cell stack system. Shortcomings of existing devices and systems will be addressed by one or more aspects of the present disclosure.

### SUMMARY

In one configuration, a fuel cell stack is provided and includes a fuel cell stack case including a chamber extending between a first end and a second end and one or more fuel cells arranged in the chamber of the fuel cell stack case. The fuel state further includes a first end plate coupled to the first end of the fuel cell stack case and including one or more first datum rail receptacles, a second end plate coupled to the second end of the fuel cell stack case and including one or more second datum rail receptacles spaced axially from the first datum rail receptacles with respect to a first axis, and one or more datum rails coupled to and extending between the one or more first datum rail receptacles and the one or more second datum rail receptacles.

The fuel cell stack may include one or more of the following optional aspects. For example, the first end plate can be fastened to the first end of the fuel cell stack case and the second end plate can be fastened to the second end of the fuel cell stack case. The one or more datum rails are coupled to the first end plate and the second end plate without fasteners.

According to at least one aspect, each of the one or more first datum rail receptacles can further include a c-shaped slot. Each of the one or more second datum rail receptacles can further include a c-shaped seat. The one or more datum rails can each include a body extending axially with respect to the first axis. The body can include a first end, a second end opposite the first end, and a channel extending between the first end and the second end. The one or more datum rails can each include a reinforcement rail coupled to the body and extend axially between the first end and the second end.

According to another aspect, the first end of the one or more datum rails can be arranged in one of the c-shaped slots of the first end plate. The second end of the one or more datum rails can be coupled to one of the c-shaped seats of the second end plate. The first end of the one or more datum rails can be coupled to the c-shaped slots with a clearance fit and the second end of the one or more datum rails can be coupled to the c-shaped seats with a slip fit.

In another configuration, a vehicle is provided and includes a vehicle body and a fuel cell stack coupled to the vehicle body. The fuel cell stack includes a fuel cell stack case including a chamber extending between a first end and a second end and one or more fuel cells arranged in the chamber of the fuel cell stack case. The fuel cell stack further includes a first end plate coupled to the first end of the fuel cell stack case and including one or more first datum rail receptacles, a second end plate coupled to the second end of the fuel cell stack case and including one or more second datum rail receptacles spaced axially from the first datum rail receptacles with respect to a first axis, and one or more datum rails coupled to and extending between the one or more first datum rail receptacles and the one or more second datum rail receptacles.

The vehicle may include one or more of the following optional aspects. For example, the first end plate can be fastened to the first end of the fuel cell stack case and the second end plate can be fastened to the second end of the fuel cell stack case. The one or more datum rails are coupled to the first end plate and the second end plate without fasteners.

According to at least one aspect, each of the one or more first datum rail receptacles can further include a c-shaped slot. Each of the one or more second datum rail receptacles can further include a c-shaped seat. The one or more datum rails can each include a body extending axially with respect to the first axis. The body can include a first end, a second end opposite the first end, and a channel extending between the first end and the second end.

According to another configuration, a fuel cell stack is provided and includes a first end plate including one or more first datum rail receptacles, a second end plate including one or more second datum rail receptacles spaced axially from the first datum rail receptacles with respect to a first axis, and one or more datum rails coupled to and extending between the one or more first datum rail receptacles and the one or more second datum rail receptacles without fasteners.

The fuel cell stack may include one or more of the following optional aspects. For example, the one or more first datum rail receptacles are c-shaped slots. The one or more second datum rail receptacles are c-shaped seats. The one or more datum rails are coupled to the c-shaped slots with a clearance fit and coupled to the c-shaped seats with a slip fit.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle including a fuel cell stack system according to principles of the present disclosure;

FIG. 2 is a perspective view of the fuel cell stack system of FIG. 1 according to the principles of the present disclosure;

FIG. 3 is a perspective view of the fuel cell stack of FIG. 2 with a fuel cell stack case removed and one or more datum rails extending between an upper end plate and a lower end plate;

FIG. 4 is a close up perspective view of a first datum rail receptacle of the upper end plate of FIG. 3 with the datum rail removed;

FIG. 5 is a close up perspective view of a second datum rail receptacle of the lower end plate of FIG. 3 with the datum rail removed;

FIG. 6 is a top view of one of the one or more datum rails arranged in the first datum rail receptacle of FIG. 4; and

FIG. 7 is a top view of one of the one or more datum rails arranged in the second datum rail receptacle of FIG. 5.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

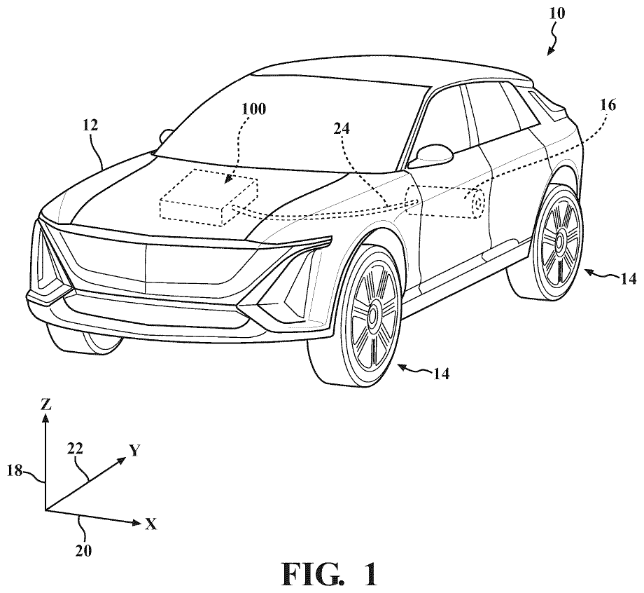

With reference to FIG. 1, a vehicle 10, such as an electric motor vehicle, is provided. The vehicle 10, includes a vehicle body 12, one or more wheels 14, and an electric motor 16 arranged in and/or coupled to the vehicle body 12. The vehicle body 12 extends along a first axis (i.e., vertical direction) 18, a second axis (i.e., cross-car or lateral direction) 20, and a third axis (i.e., fore-aft or longitudinal direction) 22. The electric motor 16 can be configured to drive one or more of the one or more wheels 14 to propel the vehicle 10. The vehicle 10 includes a fuel cell stack 100 that can be arranged in and/or coupled to the vehicle body 12 and is communicatively coupled to the electric motor 16 via an electric power cable 24.

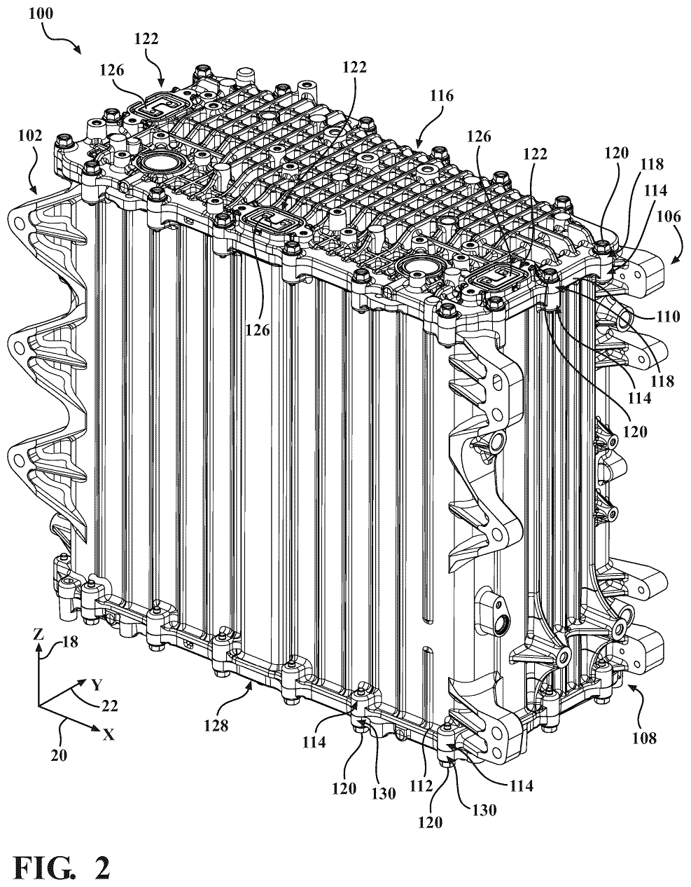

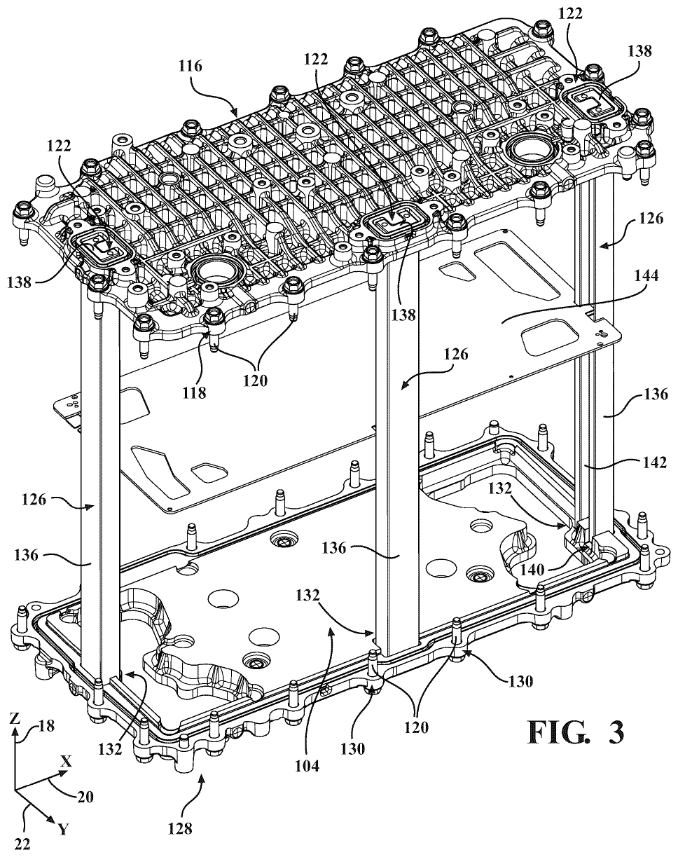

With reference to FIG. 2, an example of the fuel cell stack 100 is provided and includes a fuel cell stack case 102 comprising a chamber 104 (FIG. 3) extending between a first or upper end 106 and a second or lower end 108 with respect to the first axis 18. The fuel cell stack case 102 can include an upper flange 110 extending radially from the upper end 106 and a lower flange 112 extending radially from the lower end 108. The upper and lower flanges 110, 112 can each include one or more fastener holes 114.

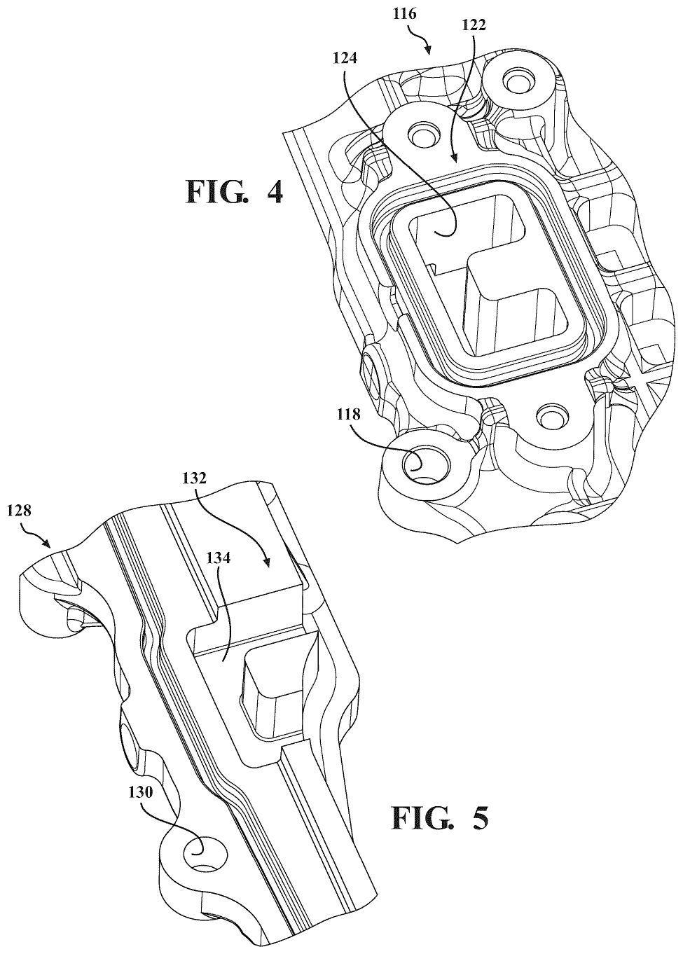

With continued reference to FIG. 2, a first or upper end plate 116 is coupled to the upper end 106 of the fuel cell stack case 102. The upper end plate 116 can include one or more fastener openings 118 spaced around a perimeter of the upper end plate 116. One or more fasteners 120 can be inserted through the fastener openings 118 with respect to the first axis 18 and fastened to the one or more fastener holes 114 of the upper flange 110. Additional or alternative methods can be used to couple the upper end plate 116 to the fuel cell stack case 102 (e.g., adhesives, welding, etc.). The upper end plate 116 includes one or more first datum rail receptacles 122, as shown in FIGS. 2 and 3. According to at least one aspect, as shown in FIG. 4, the one or more first datum rail receptacles 122 can be c-shaped openings or slots 124. As will be discussed in more detail below, each of the one or more first datum rail receptacles 122 can be configured to receive datum rails 126.

With reference again to FIG. 2, a second or lower end plate 128 is coupled to the second end 108 of the fuel cell stack case 102. The lower end plate 128 can include one or more fastener openings 130 spaced around a perimeter of the lower end plate 128. The one or more fasteners 120 can be inserted through the fastener openings 130 with respect to the first axis 18 and fastened to the one or more fastener holes 114 of the lower flange 112. Additional or alternative methods can be used to couple the lower end plate 128 to the fuel cell stack case 102 (e.g., adhesives, welding, etc.). The lower end plate 128 includes one or more second datum rail receptacles 132, as shown in FIG. 3. According to at least one aspect, as shown in FIG. 5, the one or more second datum rail receptacles 132 can be c-shaped seats 134. Each of the one or more second datum rail receptacles 132 can be configured to receive the datum rails 126. According to another aspect, with reference to FIG. 3, the second datum rail receptacles 132 are spaced axially from the first datum rail receptacles 122 with respect to the first axis 18.

The datum rails 126 can be coupled to and extend between the one or more first datum rail receptacles 122 and the one or more second datum rail receptacles 132, as shown in FIG. 3. According to one aspect, the datum rails 126 each include a body 136 that extends axially with respect to the first axis 18. The body 136 can include a first end 138, a second end 140 opposite the first end 138, and a channel 142 extending between the first end 138 and the second end 140. The datum rails 126 can be configured to guide, support, and/or retain one or more fuel cells (e.g., bipolar plates (BPP), unitized electrode assembly (UEA), etc.) 144 in the chamber 104 of the fuel cell stack case 102, as shown in FIG. 3.

According to at least one aspect, the datum rails 126 can be coupled to the first end plate 116 and the lower end plate 128 without fasteners. This can be desirable during assembly because less components required to assemble the fuel cell stack 100 results in less assembly time per fuel cell stack 100. According to another aspect, the datum rails 126 can each include one or more reinforcement rails 146 coupled to and/or extending through a portion the body 136 between the first end 138 and the second end 140.

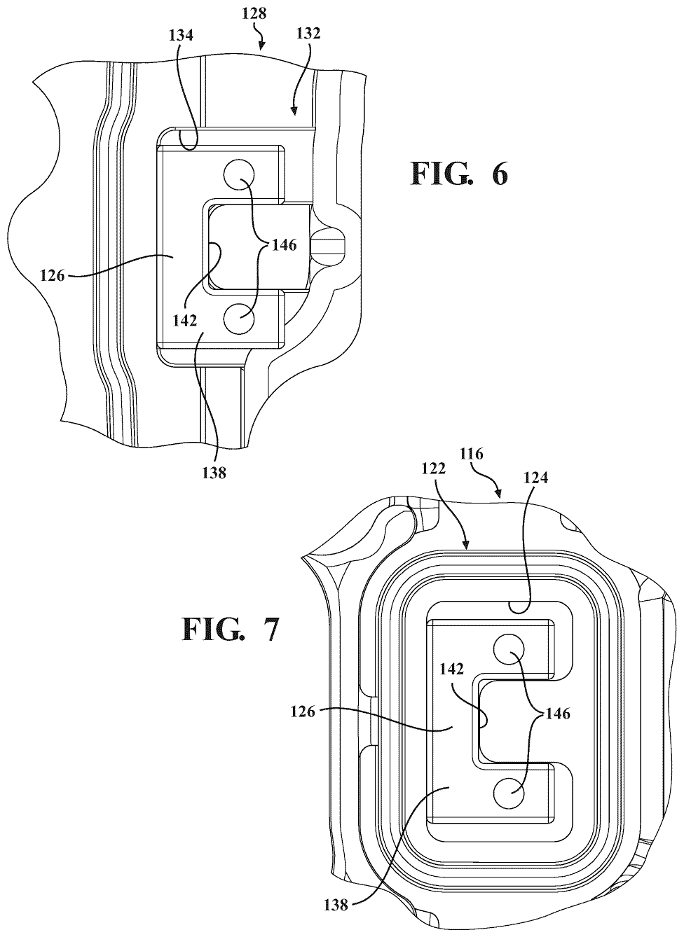

During assembly, with reference to FIG. 6, the datum rails 126 can initially be arranged in or coupled to the second datum rail receptacles 132. In other words, the second end 140 (FIG. 3) of the datum rails 126 can be coupled to the c-shaped seats 134 of the lower end plate 128. More particularly, the second end 140 (FIG. 3) of the datum rails 126 can be coupled to the c-shaped seats with a slip fit, press fit, interference fit, or friction fit. The fuel cell stack case 102 can be coupled to the lower end plate 128 so that the datum rails 126 project into the chamber 104. The fuel cells 144 can then be arranged in the chamber 104 of the fuel cell stack case 102 along the datum rails 126. The datum rails 126 can act as an electrical insulator and separate the fuel cells from the fuel cell stack case 102. Once the fuel cells 144 are arranged in the chamber 104, the first end plate 116 can be arranged on the fuel cell stack case 102 so that the datum rails 126 project into the first datum rail receptacles 122, as shown in FIG. 3. In other words, the first end 138 of the datum rails 126 can be coupled to the c-shaped slots 124. More particularly, the first end 138 of the datum rails 126 can be coupled to the c-shaped slots 124 with a clearance fit.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A fuel cell stack, comprising:
a fuel cell stack case, comprising a chamber extending between a first end and a second end;
one or more fuel cells arranged in the chamber of the fuel cell stack case;
a first end plate coupled to the first end of the fuel cell stack case and including one or more first datum rail receptacles;
a second end plate coupled to the second end of the fuel cell stack case and including one or more second datum rail receptacles spaced axially from the first datum rail receptacles with respect to a first axis; and
one or more datum rails coupled to and extending between the one or more first datum rail receptacles and the one or more second datum rail receptacles.

2. The fuel cell stack of claim 1, wherein the first end plate is fastened to the first end of the fuel cell stack case and the second end plate is fastened to the second end of the fuel cell stack case.

3. The fuel cell stack of claim 2, wherein the one or more datum rails are coupled to the first end plate and the second end plate without fasteners.

4. The fuel cell stack of claim 1, wherein each of the one or more first datum rail receptacles further includes a c-shaped slot.

5. The fuel cell stack of claim 4 wherein each of the one or more second datum rail receptacles further includes a c-shaped seat.

6. The fuel cell stack of claim 5, wherein the one or more datum rails each include a body extending axially with respect to the first axis, comprising:
a first end,
a second end opposite the first end, and
a channel extending between the first end and the second end.

7. The fuel cell stack of claim 6, wherein the one or more datum rails each include a reinforcement rail coupled to the body and extending axially between the first end and the second end.

8. The fuel cell stack of claim 6, wherein the first end of the one or more datum rails is arranged in one of the c-shaped slots of the first end plate.

9. The fuel cell stack of claim 8, wherein the second end of the one or more datum rails is coupled to one of the c-shaped seats of the second end plate.

10. The fuel cell stack of claim 9, wherein the first end of the one or more datum rails is coupled to the c-shaped slots with a clearance fit and the second end of the one or more datum rails is coupled to the c-shaped seats with a slip fit.

11. A vehicle, comprising:
a vehicle body,
a fuel cell stack coupled to the vehicle body, comprising:
a fuel cell stack case, comprising a chamber extending between a first end and a second end;
one or more fuel cells arranged in the chamber of the fuel cell stack case;
a first end plate coupled to the first end of the fuel cell stack case and including one or more first datum rail receptacles;
a second end plate coupled to the second end of the fuel cell stack case and including one or more second datum rail receptacles spaced axially from the first datum rail receptacles with respect to a first axis; and
one or more datum rails coupled to and extending between the one or more first datum rail receptacles and the one or more second datum rail receptacles.

12. The vehicle of claim 11, wherein the first end plate is fastened to the first end of the fuel cell stack case and the second end plate is fastened to the second end of the fuel cell stack case.

13. The vehicle of claim 12, wherein the one or more datum rails are coupled to the first end plate and the second end plate without fasteners.

14. The vehicle of claim 11, wherein each of the one or more first datum rail receptacles further includes a c-shaped slot.

15. The vehicle of claim 14, wherein each of the one or more second datum rail receptacles further includes a c-shaped seat.

16. The vehicle of claim 15, wherein the one or more datum rails each include a body extending axially with respect to the first axis, comprising:
a first end,
a second end opposite the first end, and
a channel extending between the first end and the second end.

17. A fuel cell stack, comprising:
a first end plate including one or more first datum rail receptacles;
a second end plate including one or more second datum rail receptacles spaced axially from the first datum rail receptacles with respect to a first axis; and
one or more datum rails coupled to and extending between the one or more first datum rail receptacles and the one or more second datum rail receptacles without fasteners.

18. The fuel cell stack of claim 17, wherein the one or more first datum rail receptacles are c-shaped slots.

19. The fuel cell stack of claim 18, wherein the one or more second datum rail receptacles are c-shaped seats.

20. The fuel cell stack of claim 19, wherein the one or more datum rails are coupled to the c-shaped slots with a clearance fit and coupled to the c-shaped seats with a slip fit.
